(19) United States
(12) Patent Application Publication
(10) Pub. No.: US 2010/0050064 A1
(43) Pub. Date: Feb. 25, 2010

(54) SYSTEM AND METHOD FOR SELECTING A MULTIMEDIA PRESENTATION TO ACCOMPANY TEXT

(75) Inventors: Zhu Liu, Marlboro, NJ (US); Andrea Basso, Marlboro, NJ (US); Lee Begeja, Gillette, NJ (US); David C. Gibbon, Lincroft, NJ (US); Bernard S. Renger, New Providence, NJ (US); Behzad Shahraray, Holmdel, NJ (US)

Correspondence Address: AT & T LEGAL DEPARTMENT - NDQ, ATTN: PATENT DOCKETING, ONE AT & T WAY, ROOM 2A-207, BEDMINSTER, NJ, 07921, US

(73) Assignee: AT & T Labs, Inc., Austin, TX (US)

(21) Appl. No.: 12/196,616

(22) Filed: Aug. 22, 2008

(51) Int. Cl. G06F 17/00

(52) U.S. Cl. 715/202

(57) ABSTRACT

Disclosed herein are systems, methods, and computer readable-media for selecting a multimedia presentation to accompany text. The method for selecting a multimedia presentation to accompany text comprises analyzing a body of text, selecting a multimedia presentation based on the body of text, and playing the selected multimedia presentation at an appropriate time simultaneous with presenting portions of the body of text. In one embodiment, the audio track comprises music, sound effects, silence, one or more ambient effect (such as dimming lights), and any combination thereof. In another embodiment, the audio track is based on content of the text, language, an associated still illustration or video clip, meta-data or a user profile. In yet another embodiment, an appropriate volume is determined for playing the selected audio track and that volume is used to adjust how loudly the selected audio track is played. Multiple multimedia presentations can be played back collaboratively and simultaneously.

### BACKGROUND OF THE INVENTION

1. Field of the Invention

The present invention relates to multimedia playback and more specifically to selecting a multimedia presentation to accompany text.

2. Introduction

Sources of spoken text have been made increasingly available with recent developments in modern technology. Before the advent of computers and modern personal electronics, most people enjoyed a book or magazine by reading the actual text with their eyes. Of course, some exceptions existed, such as Braille or where someone else read the book to them. Today there are many options to enjoy the content of a book without ever seeing so much as a single printed word on a page. People began listening to books on tape or CD. Now you can get books in MP3 or other audio format to listen to almost anywhere. The text of many books is available online at commercial or free websites, such as books.google.com or The Online Books Page hosted by the University of Pennsylvania at http://onlinebooks.library.upenn.edu. Speech to text technology provides yet another source of reading material that is not on an actual printed page.

Some sample devices that are a part of the wave of technology providing alternatives to text printed on paper are the Amazon Kindle and Sony Reader. Both are capable of storing an entire library worth of books ready for reading at any time on a small, handheld device. These devices are used practically anywhere that traditional, printed books are read. The problem with these technologies is that mood-enhancing sound tracks are not played. In these cases, the text is either available in a machine-readable format or can be converted from speech to text with relative ease. The opportunity to process and analyze the text being read is being overlooked. Accordingly, what is needed in the art is a way to enhance the user experience of reading text.

### SUMMARY

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Disclosed are systems, methods and computer-readable media for selecting a multimedia presentation to accompany text. The method for selecting a multimedia presentation to accompany text comprises analyzing a body of text, selecting a multimedia presentation based on the body of text, and playing the selected multimedia presentation at an appropriate time simultaneous with presenting portions of the body of text. In one embodiment, the audio track comprises music, sound effects, silence, one or more ambient effect (such as dimming lights), and any combination thereof. In another embodiment, the audio track is based on content of the text, language, an associated still illustration or video clip, meta-data or a user profile. In yet another embodiment, an appropriate volume is determined for playing the selected audio track and that volume is used to adjust how loudly the selected audio track is played. Multiple multimedia presentations can be played back collaboratively and simultaneously.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only exemplary embodiments of the invention and are not therefore to be considered to be limiting of its scope, the invention will be described and explained with additional specificity and detail through the use of the accompanying drawings in which:

FIG. 1 illustrates an example system embodiment;

FIG. 2 illustrates a method embodiment for selecting a multimedia presentation to accompany text;

FIG. 3 illustrates an electronic book reader that plays a multimedia presentation to accompany text;

FIG. 4 illustrates how an electronic book reader communicates with a server to select audio;

FIG. 5 illustrates a digital audio player capable of reading recorded books with audio to accompany text; and

FIG. 6 illustrates a combination engine in the context of adaptive content augmentation.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

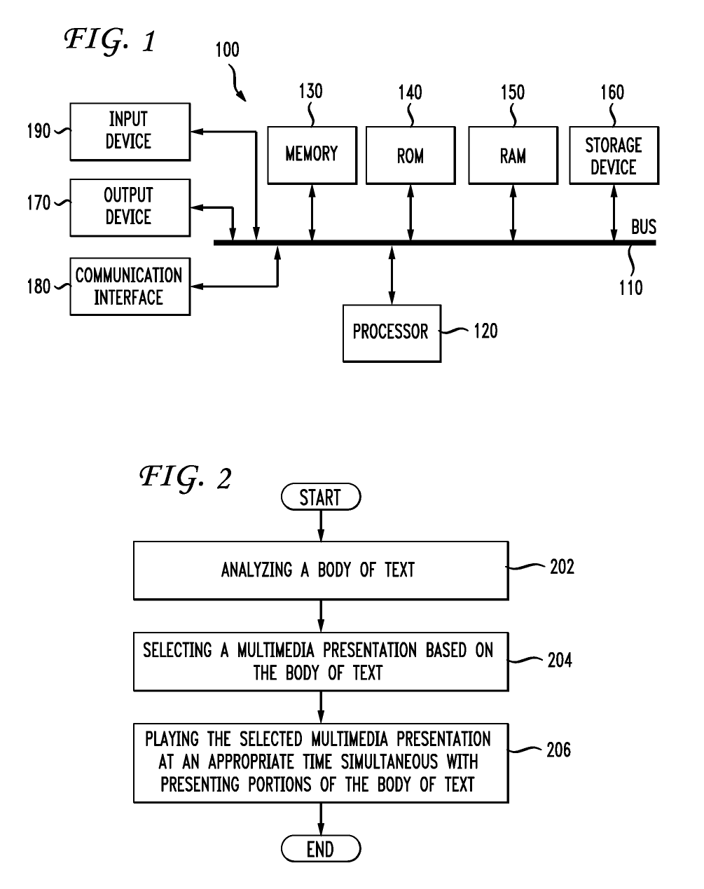

With reference to FIG. 1, an exemplary system includes a general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. In one aspect, a hardware module that performs a particular function includes the software component stored in a tangible computer-readable medium in connection with the necessary hardware components, such as the CPU, bus, display, and so forth, to carry out the function. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The input may be used by the presenter to indicate the beginning of a speech search query. The device output 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

FIG. 2 illustrates a method embodiment for selecting a multimedia presentation to accompany text. The method may be implemented on any number of systems or devices depending on the particular application. In some instances multiple devices work in concert to provide the multimedia experience, such as lights, speakers, video displays, and other multimedia related devices. An exemplary system converts speech to a body of text. In one aspect of the invention, the speech is natural or synthetically generated speech. One example of natural speech is a pre-recorded MP3 of a narrator reading the text of a book. Another example is a book on tape or CD. Natural speech is not necessarily required to be pre-recorded. Natural speech also includes live speech, such as an author reading portions of her book aloud to a group in a bookstore. Blended pre-recorded and live speech is also contemplated. Synthetic speech encompasses other, non-natural speech. One example of a source of synthetic speech is computer-synthesized speech such as speech generated by text-to-speech processes. A few high-end examples of such computer-synthesized speech is the technology used by Stephen Hawking to communicate or sophisticated text-to-speech technology employed by automated call center systems, while a low-end example of such computer-synthesized speech is a Speak and Spell electronic toy. Other types of synthetic speech typically fall somewhere between these two extremes.

In some aspects of the invention, converting the speech to a body of text is done in advance, and in some it is done as the text is read. In the case of an electronic book reader, the entire body of text is known in advance and can be analyzed in advance. The original source does not have to be speech inasmuch as the text may be directly processed.

After speech is converted to text and/or other text is received, the method analyzes the body of text 202 and selects a multimedia presentation based on the analysis of the body of text 204. In one aspect, selecting an audio track is based on content of the text, language, an associated still illustration or video clip, meta-data or a user profile. The content of the text is the actual words of the text. The text is analyzed by one or more of topic segmentation, topic categorization, keyword extraction, salient word extraction, and named entity extraction. These and other relevant techniques may be applied to understand the context, emotions, characters, etc. and can identify particular textual passages that correspond to selections from other media. In one example, a user reads “Peter and the Wolf” by Prokofiev. When the user reads about the Grandfather, the system identifies that character and selects multimedia presentations centered around the Grandfather's character, namely the bassoon. Likewise, when the user reads about the Wolf, the system selects a multimedia presentation with three French Horns and dims the lights to create a sinister mood as part of the multimedia presentation. In another example, if the content of the text is a book based on a motion picture, then an appropriate audio track is the official movie soundtrack. Often, text will contain non-native phrases or words. In these cases, the language spoken, such as Spanish or Japanese, may influence the audio track selected. As an example, if Japanese is spoken, Noh or Kabuki music is selected as part of the audio track, or if Spanish is spoken, Jota or Flamenco music is selected as part of the audio track.

Electronic books can contain illustrations, much as real books do. Electronic books have the additional ability to display video clips. Illustrations or video clips offer additional insight into which multimedia presentation is appropriate to select. For example, an electronic book about skates could be unclear whether it is about skates as fish or skates as footwear. In one embodiment, an illustration assists in making a decision to play classical music to accompany text about the mystical underwater world of skates or punk rock to accompany text about a skate competition. Video clips are used in a similar fashion. Descriptions or captions associated with still illustrations or video clips are included in the term meta-data.

In one embodiment, meta-data is used to select an audio track. Meta-data is used to describe the content, themes, intended emotional impact, etc. For example, if meta-data indicates that a portion of text is intended to be humorous, then a laugh track or humorous music is selected. If meta-data indicates an explosion is about to occur, then dramatic, action-based music is selected. If meta-data indicates that a critical plot detail is about to be revealed, then tense music is selected.

Meta-data can be manipulated by the user to change the selected audio track. Meta-data may be an indication to play a particular multimedia presentation at a particular time. In this way, meta-data may serve as a markup language. Meta-data as a markup language allows for a user to customize their experience while consuming the text or in advance of consuming the text. The meta-data as a markup language for audio tracks may be included as part of a larger markup language allowing for other features as well. For example, meta-data as a markup language may include instructions to dim the lights in a room, turn on a fireplace, vibrate a device, or open a picture at a specific time. Users can alter meta-data or the meta-data can be included as part of the text before a user consumes it.

Another aspect relates to a user profile. A user profile can contain user preferences, a user history, or other information about the user. For example, a user who enjoys the thrill of horror books can indicate that such books should be accompanied by multimedia presentations to maximize the shock of the scary portions without knowing in advance where the scary portions are. A user profile containing a history of user actions can be used to predict what the user desires in similar situations. User profiles may be preset for different circumstances and locations, such as in a restaurant, at home, on the bus, etc. Different locations, such as on the bus, may require more attention to surroundings (so the user doesn't miss her bus stop), so less engrossing multimedia presentations are selected than the multimedia presentations which would be selected for home.

The multimedia presentations comprises music, sound effects, silence, one or more ambient effect, and/or any combination thereof. An example of music is an official, licensed soundtrack to go along with a movie novelization. Some examples of sound effects include applause, bells, the sound of a busy street, a babbling brook, etc. In an example where the text is a Christmas story, then sleigh bells, carols, or chimes could be selected as the audio track. A user may enable or disable the audio track at will, similar to a mute button on a TV or a CD/DVD player. Examples of ambient effects include dimming or flickering lights, vibration of a reading device, rumbling of a massage chair, turning on a fireplace, changing the color of lights, playing video on a television set or a digital picture frame, turning on a fan, heater, air conditioner, etc. Any device which may be controlled remotely to change ambient sensations or conditions may be incorporated into an ambient effect.

Third, the method plays the selected multimedia presentation at an appropriate time simultaneous with presenting portions of the body of text 206. In one aspect, the selected multimedia presentation is played at a variable speed to align with the body of text as portions of the text are either virtually presented to the user for reading or are “spoken” in an audio book and the like. Certain books can be consumed quickly without much thought, while other books are denser and require a slower rate of consumption for pondering and meditation. Also, some people adjust the playback speed of text in order to consume more text in a shorter period of time. In these cases, the multimedia presentation is adjusted to align with certain events in the text. The audio track is not necessarily sped up, although it can be. However, the distortion associated with speeding up audio is not typically desirable. Rather, abbreviated or edited portions of the selected audio track can be used. Aligning the multimedia presentation with the speech is especially important if the multimedia presentation contains sound effects. If a sound effect comes too early or too late, the result can be distracting or can even give away plot details too early, ruining a story.

In another aspect, the method can determine an appropriate volume for playing audible portions of the selected multimedia presentation, and adjust the volume of the audible portions of the selected multimedia presentation based on the determined volume. Some basic examples of this are romantic scenes where audio tracks are intended to be quiet or chase scenes that indicate a loud, heart-pounding audio track. The determination of volume can be made based on meta-data, the content of the text, or any other suitable source.

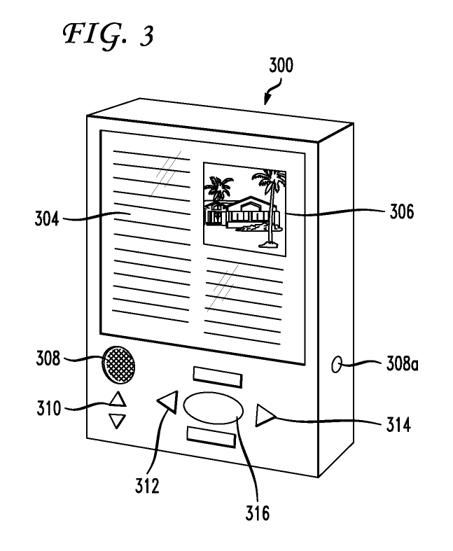

FIG. 3 illustrates an exemplary embodiment of an electronic book reading system that plays audio to accompany text. While the system described outputs audio, one variation includes communication with one or more other devices in concert to provide ambient effects. The system 300 displays text 304 as well pictures 306 to a user. The system outputs audio to the user via a built-in speaker 308 or via a headphone jack 308a. The audio is made up of a musical sound track and sound effects. The system aligns the music and sound effects with the content the system displays. The system determines an appropriate volume for the music and sound effects. Volume is further controlled by input from the user via volume up and down buttons 310. The system allows for navigation through the text via backward 312 and forward 314 buttons. As the user presses these buttons and the next portion of text is displayed, the system transitions between the music and sound effects for the former and the current portions of the text, if necessary. Often the basic mood of the text does not change appreciably between pages, so the music and sound effects will remain substantially the same. The system has a button for toggling the system on and off 316. When the system is turned off, the system holds or pauses the music and audio accompanying the text so that playback is resumed at the same spot when the system is turned on again. Amazon's Kindle), Sony's ReaderR, Cybook Gen3R, and iRex's iLiad™ are possible commercial products that can incorporate the described system.

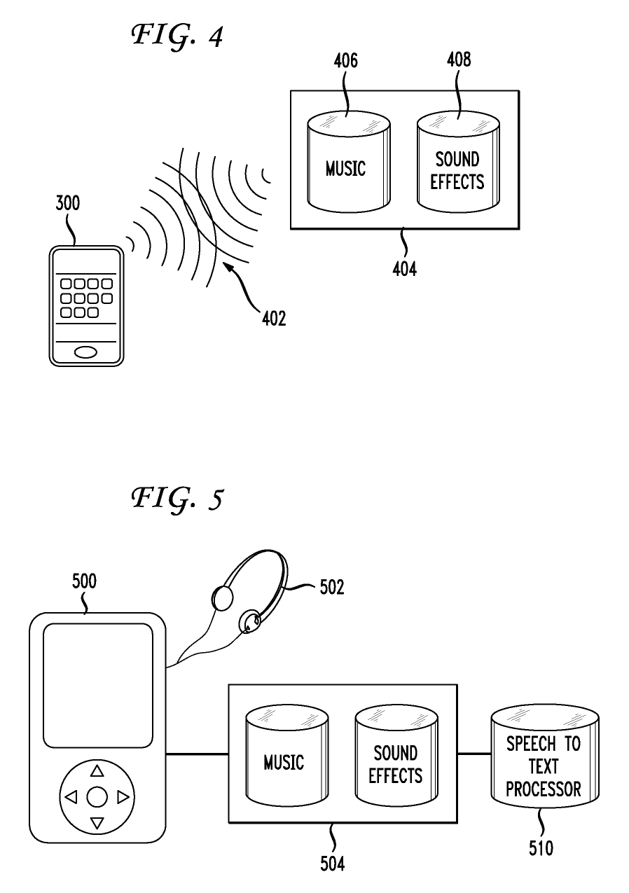

FIG. 4 illustrates how an exemplary embodiment of an electronic book reading system 300 that plays audio to accompany text, like the one illustrated in FIG. 3, communicates with a server to select audio for playback. The book reading system 300 communicates wirelessly 402 to a server 404. The system is illustrated as communicating wirelessly directly to the server, but the system may communicate via wired, wireless, or a combination of both wired and wireless links, including repeaters, routers, hubs, and switches. The system 300 transmits information to the server 400 such as the text currently displayed, user preferences, pictures, themes, meta-data, etc. The server processes the information received and selects from a database of music 406 and a database of sound effects 408 which are an appropriately synchronized with the text currently displayed. The server then transmits the selected music and/or sound effects to the system 300 for playback. In systems with adequate storage, the system requests music and sound effects for the next few pages (1, 5, 10, or however many is reasonable) and caches them locally to avoid communicating too frequently. If caching the next few pages is not logical, the system requests music and sound effects for the predicted next locations for caching. The same principles may extend beyond simple audio and may be applied to any portion of a multimedia presentation, including audio, video, secondary text, sound tracks, sound effects, and ambient effects.

FIG. 5 illustrates a digital audio player system 500 capable of reading recorded books with audio to accompany text. In the context of an MP3 player, recorded books are audio books in MP3 format. While an MP3 player system is discussed, recorded books also encompass books on tape, CD, or other audio storage devices. The system stores recorded books in audio format which are played to the user through headphones 502. As the recorded books are played back, the system sends information regarding the currently playing recorded book to a module 504 similar to the server 404 in FIG. 4. The module in this illustration is depicted outside the system, but may be located inside the system. The module contains a database of music 506 and a database of sound effects 508. The module processes the currently playing recorded book through a speech to text processor 510. Based on the results of converting the recorded book to text, the system selects music and/or sound effects from the music and sound effects databases for playback simultaneous with the recorded book. In one embodiment, the music and/or sound effects are played monaurally in one ear bud while the audio book is played in the other ear bud. In another embodiment, the music and/or sound effects and the audio book are played in stereo in both ear buds. In this case, the music volume is tied to the volume of the audio book so as not to overpower the audio book or make it difficult to hear. The system pauses playback of the audio book to accommodate an extremely loud sound effect, such as an explosion or a door slamming shut.

The music and sound effects databases may include other audio files on the digital audio player. One implementation of this is an Apple iPod playing an MP3 audio book on politics by Rush Limbaugh. As the Rush Limbaugh MP3 is playing, the iPod selects a second MP3 song to play in the background while the Rush Limbaugh MP3 is playing. One appropriate second song is “The Star-Spangled Banner” by Francis Scott Key.

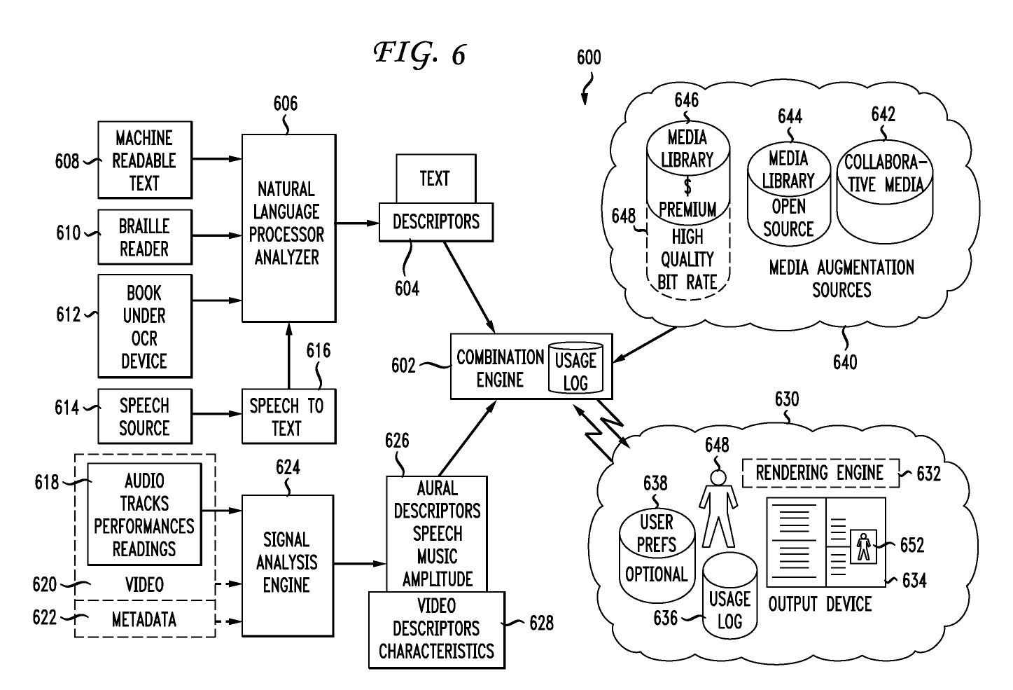

FIG. 6 illustrates a combination engine 602 at the center of an adaptive context augmentation network. In this case, various components may interact via a network such as the internet, a wireless network or other network with various other components. In another aspect, all of the systems may be operative in a single computing device. As is shown in FIG. 6, a natural language processor may receive input from various sources. Text 608, brail reader information 610, a book that is processed under an optical character recognition device 612 and speech received from a speech source 614 may be processed via a speech-to-text or automatic speech recognition system 612. All of these inputs are received by an analyzer 606 that will analyze the text and provide information regarding the content of the text. Some techniques that may be used include topic segmentation, topic categorization, keyword extraction, salient word extraction, named entity extraction, etc. In one aspect the text itself is communicated to a module 604 that includes in one aspect the text or descriptors and in another aspect both the text and descriptors of the content. This information is communicated from the combination engines 602.

Audio tracks of performances and recordings 618 may be provided to a module that provides a signal analysis 624. The signal analysis engine may also receive video 620 and/or metadata 622 to provide other detailed information regarding audio tracts and performances. An example of such processing may include receiving classical music and processing that to identify and associate a particular audio tract or other signal with an oral description that may relate to speech, music, amplitude volume and so on 626. Furthermore, there may be video descriptors characteristics 628 that may be included as well.

In an example at this stage of the above description, consider a book that has been made into a movie. The text of the book 608 may be processed by an actual language processor to obtain descriptors that help to analyze and process the text. Additionally, the audio track, video metadata and other information from the movie that is made from the book also may be processed in a signal analysis engine 624 to further obtain oral descriptions and video descriptors characteristics 628 that may be also communicated to the combination engine 602.

With this information, the combination engine may communicate with a media augmentation service or source 640 that includes various libraries. For example, there may be a media library 646 that is licensed and costs a premium but has a high quality bit rate 648 for high quality audio. An open source media library 644 may be provided as well as a collaborative media library 642. Certainly, other sources of media may be provided. The media may be communicated from the media augmentation source 640 to the combination engine and combined with one or more other sources of information received at the combination engine which is then communicated to a user output device 634 associated with a user 648. Cloud 630 represents the various one or more devices that may be associated with the user. For example, this may represent a desktop computer 634 or a mobile device. A rendering engine 632 is shown as a component of the output device. In another aspect, the combination engine 602 merely streams a bitstream which may be compatible with one or more standard based protocols. In one aspect, the combination engine 602 does the off-line heavy lifting and performs the processing associated with providing an augmented media presentation which is output on the device 634. In another aspect, various descriptors and metadata may be communicated in part or in whole from combination engine 602 and partially processed by the rendering engine 632 on the output device 634 or in a closer proximity to the user 648 but still within the user's environment 630 for further processing of the media augmentation.

Other aspects disclosed in FIG. 6 include a usage log 636 to improve the services by providing feedback to the rendering engine 632. One example of the application of the usage log may be that if the particular output device includes an electronic book in which the user is reading the book and from the media augmentation source 640 a particular background audio is selected based on the analysis of the text of the book, but when the user actually reads the book the user turns off that particular audio selection, then such usage may be stored in the usage log 636 which may prompt the system to select a different background music when the user returns back to the book and continues reading.

Of course, it is contemplated that the user may interact easily with the output device in order to select or manage the receipt of the media augmentation sources. For example, the user may request a specific sound track from a movie, may select or request other languages. For example, if the user is reading the text in English but it is known through metadata or other sources that the original language was in Chinese, then the selected music may reflect the culture of the original language or other language. The user may select a basic background music that is unrelated to the content or may be selected from a playlist from another device such as an iPOD. Of course, as has been discussed above, the music may be content specific music based on the natural language processing and analyzing of the text. In another aspect, the exemplary system matches music to a particular scene based on the metadata. In the example of the movie “Jaws”, the text of the book “Jaws” 608 is processed in connection with the video of the movie “Jaws” 620 as well as metadata 622 that identifies various scenes. The media library 646 that is selected may be the actual audio track from the movie itself. In this regard, the experience of the user 648 involves the user actually reading the text of the book “Jaws” on an electronic output device simultaneous with the actual music for various Jaws' scenes as the user reads corresponding portions of the book.

Furthermore, either automatically or manually from the user, the audio may be altered in the mix. For example, the amplitude and effects throughout the playback may be altered in view of user selection or other automated decision making.

In one aspect of the disclosure, the combination engine 602 will combine various streams. For example, there may be an audio track of an Edgar Allen Poe story that may only include text, the combination engine may therefore select the appropriate media augmentation background music and combine those streams into a particular bitstream that includes the augmented media as well as the original media. In this regard, the bitstream may also be constructed according to a standard such as MPEG, AAC, or any other industry standard that can be processed and generated by the combination engine 602.

In another aspect, a content provider may generate metadata or tags associated with the content that the output device 634 uses to coordinate playback. In this context, a book on tape or an electronic book 608 may be provided with descriptor 604 and may not necessarily need to be processed dynamically but may be preprocessed by a content provider. In this regard, the combination engine may simply receive the text with particular tags that may be used to identify various media from the media augmentation sources 640 which can then be retrieved and combined in the combination engine 602 and delivered to the user. Furthermore, if processing is done not on line but is performed locally, the combination engine may simply forward the text to the output device 634. In one aspect, the output device coordinates playback with other devices to provide a comprehensive ambient multimedia presentation. One example of this when a user reads a scary book. The output device coordinates various environmental features of the room or building to provide a scary environment to enhance the book. The output device can dim the lights, provide frightening music, flicker the lights, make noises or rumblings in various devices throughout the room as if someone was there, etc.

Utilizing the information in the tags inserted by the content provider, a local rendering engine 632 can utilize local media augmentation information and present and combine the information into an overall multimedia experience on the output device and/or other devices which can assist in the multimedia playback. In another aspect, the combination engine 602 or the rendering engine 632 may communicate with a user's local library of media, such as an iTunes library, and select from that local library, the appropriate media that may be a closest match to the particular tags, descriptors or metadata associated with the original media presentation and combine that media augmentation information with the original media to present an improved media experience on the output device 634.

In this regard, an aspect of the disclosure involves combining various media elements into a unique instantiation of the ultimate media experience presented to the user. As an alternate aspect, the media presented on the output device may include inserting a movie frame into an e-book at an appropriate place. In this example, assume that the text 608 that is received is the text of the movie Star Wars. In this case, the text may be analyzed and processed along with the video 620 of the movie itself. The combination engine may combine the basic text of an e-book and insert at various places a movie frame at an appropriate location in the book such that when the user reads on an output device 634 the text itself, there is an augmentation of the presentation which includes a movie frame at the appropriate place. This is shown as feature 652 on the output device 634 in which a movie frame is inserted. In another aspect, not only a single frame but a short clip of the video may be presented along with appropriate audio in addition to other audio that may be combined is disclosed herein. Overall, this generates a new and perhaps personalized instantiation of a media presentation.

In one aspect, readers may read at different levels and an individual user may also read at a different speed on different days. For example, some days the user may be able to focus and read faster and other days the user may be more distracted, tired and so forth and read slower. One aspect involves adjusting the media augmentation in order to adapt to the speed that the reader consumes the text. Therefore, as a user may be approaching the end of a chapter and thus, the end of an audio track that is augmenting the text based media, the system may identify or project the speed at which the user will finish the chapter and make adjustments to the secondary augmented audio track in order to smoothly and naturally end the augmentation audio.

One example application of the principles disclosed herein would be the presentation of a news broadcast. In this regard, a user may receive a synthetic voice that is combined with web content to synthesize a news-like broadcast with the various alternate elements which may include media augmentation from the sources 640 and so forth.

In another aspect, when a user is listening to a book on tape, the media augmentation sources may be based on a paragraph-by-paragraph analysis, or an intra-paragraph analysis or the particular analysis could be based on an overall length and a selection and may be selected based on particular music lengths. For example, the natural language processor and analyzer 606 as well as the other analysis engines may match both the information according to the usage log 636 to understand how long it will take a user to read, for example, a chapter in the book and then with that estimated time, select the appropriate media from the media augmentation sources 640 that matches that time in order to identify and match the lengths of the augmented media services. In another aspect, various sound effects may be simple and related to the content on the page. In another aspect, the media augmentation sources that are provided to the combination engine 602 may be based not only on the usage log 636 and other elements disclosed herein, but also based on localized regional areas. For example, if the device 634 also has a location based capability, then the system may identify that the user is in the southern part of the United States, the northeast, or in the west and such state information may affect the choice of media for media augmentation sources 640. Other aspects are also beneficial to the present invention. For example, there may be oral effect tools that are available such as a markup language that may be in the network or in the device. These oral effect tools are known to those of skill in the art and may be made available to make modifications and adjustments to audio or video or a combination of both in the augmented media.

In another aspect, there may be collaborative aspects to the present disclosure. For example, there may be a group of users or a classroom of users or any other kind of organization which there may be shared marked up content in a group. In this aspect, there may be a group of users in a department or in some other defined grouping in which there may be user generated sound effects that are shared on site and edited on site that are associated with a specific group of users. One example of this may involve a group involved in a book club in which all of the members of the book club are reading the same content and there may be a benefit of enabling a shared approach to the media augmentation services. Collaborative simultaneous playback may occur when a group of readers are nearby each other. The multimedia presentation from each may be blended into a “community” presentation. Such a collaborative presentation may give subtle clues as to what the others are reading. For example, if two friends are reading different books and suddenly the lights dim, one friend can ask the other what is going on in their book that caused the lights to dim. Music, sound effects, and other ambient effects can be combined partially or in their entirety. User preferences may be established to control the manner and extent of any collaborative simultaneous playback, including a setting to disallow collaborative simultaneous playback.

In another aspect, the output device 634 and/or combination engine 602 or other elements may also be in communication with a control device that may be in an office or in a home. For example, there may be a device within a home that is enabled to receive state or other data from a device that is in communication with the combination engine 602 and/or output device 634. The home device (not shown) may include the ability to enhance lighting or other visualizations within an automated environment. In this regard, an aspect of the disclosure includes not only using the combination engine 602 and/or the rendering engine 632 to augment the media shown in the output device but also wherein a signal may be transmitted to this other device which adjusts the lighting in the room based on such information as the descriptors, metadata and/or analysis of the text and/or video as disclosed herein. This provides another aspect of the overall experience for the user in which the overall environment may be controlled.

A simple example of this may be wherein the lights are dimmed when the characters in the book enter a cave. Thus, as the user reads the books and there may be augmented audio that has a spooky characteristic to it, in addition to the audio, the system communicates with a home unit and dims the lights and plays noises of dripping water and bats rustling in the darkness to give the user a more realistic experience of actually being in the cave as well. In another aspect, wherein the usage log 634 may indicate that the user 648 is actually overly scared and desires to have it actually brighter in scary moments, then the user preferences 638 may also be employed to make appropriate adjustments which may otherwise be in conflict with the information received from associated descriptors of the original content.

In another aspect, the original content may have pointers to various providers. Thus, a content provider of an electronic book may include descriptors or content that may point to a particular media library 646 that may have particularly appropriate augmentation media in addition to the original media. For example, there may be enhanced sound effects that can be linked to the output device in MP3. There may be high quality add-ons. Thus, several aspects of the present disclosure involve recreating and modifying the media according to enhance the experience when the media is consumed by the user.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. When a “tangible” computer readable media is recited, it expressly excludes an air or wireless interface or software per se. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the invention. For example, the processes described herein may have application in electronic children's books or book clubs. Those skilled in the art will readily recognize various modifications and changes that may be made to the present invention without following the example embodiments and applications illustrated and described herein, and without departing from the true spirit and scope of the present invention.

We claim:

1. A method of selecting a multimedia presentation to accompany text, the method comprising:
analyzing a body of text;
selecting a multimedia presentation based on the body of text; and
playing the selected multimedia presentation at an appropriate time simultaneous with presenting portions of the body of text.

2. The method of claim 1, wherein the multimedia presentation comprises music, sound effects, silence, one or more ambient effect, and any combination thereof.

3. The method of claim 1, wherein selecting a multimedia presentation is based on one or more of content of the text, language, an associated still illustration or video clip, meta-data or a user profile.

4. The method of claim 1, the method further comprising:
determining an appropriate volume for playing the audible portions of the selected multimedia presentation; and
adjusting a volume of the audible portions of the selected multimedia presentation.

5. The method of claim 1, wherein the selected multimedia presentation is played at a variable speed to synchronize with a consumption rate of the body of text.

6. The method of claim 1, wherein multiple multimedia presentations based on multiple bodies of text are played back collaboratively and simultaneously.

7. The method of claim 1, wherein text is analyzed by one or more of topic segmentation, topic categorization, keyword extraction, salient word extraction, and named entity extraction.

8. A system for selecting a multimedia presentation to accompany text, the system comprising:
a module configured to analyze a body of text;
a module configured to select a multimedia presentation based on the body of text; and
a module configured to play the selected multimedia presentation at an appropriate time simultaneous with presenting portions of the body of text.

9. The system of claim 8, wherein the multimedia presentation comprises music, sound effects, silence, one or more ambient effect, and any combination thereof.

10. The system of claim 8, wherein selecting a multimedia presentation is based on one or more of content of the text, language, an associated still illustration or video clip, meta-data or a user profile.

11. The system of claim 8, the system further comprising:
a module configured to determine an appropriate volume for playing the audible portions of the selected multimedia presentation; and
a module configured to adjust a volume of the audible portions of the selected multimedia presentation.

12. The system of claim 8, wherein the selected multimedia presentation is played at a variable speed to synchronize with a consumption rate of the body of text.

13. The system of claim 8, wherein multiple multimedia presentations based on multiple bodies of text are played back collaboratively and simultaneously.

14. The system of claim 8, wherein text is analyzed by one or more of topic segmentation, topic categorization, keyword extraction, salient word extraction, and named entity extraction.

15. A computer-readable medium storing a computer program having instructions for selecting a multimedia presentation to accompany text, the instructions comprising:
analyzing a body of text;
selecting a multimedia presentation based on the body of text; and
playing the selected multimedia presentation at an appropriate time simultaneous with presenting portions of the body of text.

16. The computer-readable medium of claim 15, wherein the multimedia presentation comprises music, sound effects, silence, one or more ambient effect, and any combination thereof.

17. The computer-readable medium of claim 15, wherein selecting a multimedia presentation is based on one or more of content of the text, language, an associated still illustration or video clip, meta-data or a user profile.

18. The computer-readable medium of claim 15, the instructions further comprising:
determining an appropriate volume for playing the audible portions of the selected multimedia presentation; and
adjusting a volume of the audible portions of the selected multimedia presentation.

19. The computer-readable medium of claim 15, wherein the selected multimedia presentation is played at a variable speed to synchronize with a consumption rate of the body of text.

20. The computer-readable medium of claim 15, wherein multiple multimedia presentations based on multiple bodies of text are played back collaboratively and simultaneously.
